(19) United States
(12) Patent Application Publication
(10) Pub. No.: US 2018/0171443 A1
(43) Pub. Date: Jun. 21, 2018

(54) HOT ROLLED STEEL PLATE FOR OIL WELL PIPE, STEEL PIPE USING THE SAME, AND METHOD OF MANUFACTURING THE SAME

(71) Applicant: POSCO, Pohang-si (KR)

(72) Inventors: Min Sung Joo, Gwangyang-si (KR); Kyung Min NOH, Gwangyang-si (KR)

(21) Appl. No.: 15/843,843

(22) Filed: Dec. 15, 2017

(30) Foreign Application Priority Data
Dec. 21, 2016 (KR) 10-2016-0176115

(51) Int. Cl. C22C 38/14; C22C 38/12; C22C 38/06; C22C 38/04; C22C 38/02; C22C 38/00; C21D 8/02; C21D 9/08

(52) U.S. Cl. CPC C22C 38/14; C22C 38/12; C22C 38/06; C22C 38/04; C22C 38/02; F16L 9/02; C22C 38/001; C21D 8/0226; C21D 9/08; C21D 2211/009; C21D 2211/005; C22C 38/002

(57) ABSTRACT

The present invention relates to a hot rolled steel plate used for an oil well pipe for development of petroleum or natural gas, a steel pipe manufactured using the same, and a method of manufacturing the same.

### CROSS-REFERENCE TO RELATED APPLICATION

This application claims the benefit of priority to Korean Patent Application No. 10-2016-0176115, filed on Dec. 21, 2016 with the Korean Intellectual Property Office, the entirety of the disclosure of which is incorporated herein by reference.

### BACKGROUND

The present disclosure relates to a hot rolled steel plate used in an oil well pipe for the development of petroleum or natural gas resources, a steel pipe manufactured using the same, and a method of manufacturing the same.

At present, for a steel pipe for an oil well pipe used in the development of petroleum or natural gas resources, a seamless steel pipe is mainly used. Such a steel pipe is classified using American Petroleum Institute (API)-5CT steel pipe grades (Grades H40, J55, K55, and N80) according to the specifications.

Generally, steel for an oil well pipe is required to have high strength, compressive strength for resisting internal and external pressure, toughness, delayed fracture resistance, and the like. In a portion thereof, impact energy of 30J or more is required at 0° C. In general, a method of manufacturing a seamless steel pipe used for an oil well pipe is as follows: a billet heated at a high temperature is punched by a drilling mill, a rolling mill such as a plug mill, a mandrel mill, or the like, is used for rolling, a shaft diameter or thickness is processed using a reducer or a sizer, and quenching and tempering heat treatments are performed.

However, the method described above has disadvantages in that it is necessary to install a heating furnace and a soaking pit for performing quenching and tempering heat treatments, and high manufacturing costs may be incurred.

For this reason, recently, a steel pipe obtained by pipe-making a low-cost hot rolled steel plate, rather than a seamless steel pipe, has been used in oil well pipes. Regarding such a steel pipe, a round coil is flattened by leveling, and both ends are cut out. Thereafter, edges, abutted when a pipe is formed to have a round shape using a roller, are welded, so a pipe is manufactured from a welded steel plate, and an example thereof is disclosed in Patent Document 1.

On the other hand, a steel used in a welded steel pipe has yield strength defined in API-5CT specifications, according to intended purpose. For example, a steel plate for a steel pipe is manufactured using different manufacturing methods according to respective yield strength levels, such as 55 ksi-grade J55 steel and 110 ksi-grade P110 steel, and is ultimately manufactured as a welded steel pipe.

However, in recent years, environments in which oil wells and gas wells (hereinafter, collectively referred to as oil wells) are developed have become increasingly harsh, and efforts to lower production costs have been accelerated in order to improve profitability. In detail, in order to improve profitability, unlike in the case of the examples described above, it has recently been necessary to use a single type of steel for various purposes.

For example, in the case of a steel having 55 Ksi-grade yield strength, such as J55, a low alloy steel, the steel is usually used without heat treatment. In the case of P110, a steel having 110 Ksi-grade yield strength, after an additional alloy is added to secure hardenability, strength is secured through quenching and tempering heat treatments. However, when J55 and P110 characteristics are integrated into a single steel, such integration is economical because the steel realized thereby can meet a range of demands efficiently and flexibly.

As described above, in the case of steel in which P110 grade and J55 grade characteristics are integrated, an alloying element should be added for securing hardenability, so that the manufacturing process may have higher manufacturing costs, as compared to non-heat treated J55 manufactured as a single steel grade. In order to overcome the problem described above, it is necessary to reduce an amount of an alloying element and precisely control manufacturing conditions such as cooling, and the like. However, there may be a problem in that a complicated phase transformation phenomenon may occur during cooling, so that deviations in hot rolled coil length, width, and shape, or the like, may occur.

### RELATED ART DOCUMENT

(Patent Document 1) Japanese Patent Laid-Open No. 2011-246793

### SUMMARY

An aspect of the present disclosure provides a hot rolled steel plate for an oil well pipe having yield strength and tensile strength according to an API specification after pipe-making, a welded steel pipe having 55 Ksi-grade yield strength before heat treatment after pipe-making, a welded steel pipe having 110 Ksi-grade yield strength after heat treatment, and a method of manufacturing the same.

The scope of the present disclosure is not limited to the above-mentioned aspects. Other aspects of the present disclosure are stated in the following description, and the aspects of the present disclosure will be clearly understood by those having ordinary skill in the art through the following description.

According to an aspect of the present disclosure, a hot rolled steel plate for an oil well pipe may include: carbon (C): 0.2 wt % to 0.3 wt %, silicon (Si): 0.10 wt % to 0.50 wt %, manganese (Mn): 1.0 wt % to 2.0 wt %, titanium (Ti): 0.01 wt % to 0.03 wt %, boron (B): 0.001 wt % to 0.005 wt %, calcium (Ca): 0.001 wt % to 0.006 wt %, nitrogen (N): 0.008 wt % or less, aluminum (Al): 0.01 wt % to 0.05 wt %, phosphorous (P): 0.025 wt % or less, sulfur (S): 0.005 wt % or less, with a remainder of iron (Fe) and unavoidable impurities, wherein a microstructure, at a depth of 1 mm below a surface, includes ferrite and pearlite.

According to another aspect of the present disclosure, a method of manufacturing a hot rolled steel plate for an oil well pipe may include: reheating a steel slab including carbon (C): 0.2 wt % to 0.3 wt %, silicon (Si): 0.10 wt % to 0.50 wt %, manganese (Mn): 1.0 wt % to 2.0 wt %, titanium (Ti): 0.01 wt % to 0.03 wt %, boron (B): 0.001 wt % to 0.005 wt %, calcium (Ca): 0.001 wt % to 0.006 wt %, nitrogen (N): 0.008 wt % or less, aluminum (Al): 0.01 wt % to 0.05 wt %, phosphorous (P): 0.025 wt % or less, sulfur (S): 0.005 wt % or less, with a remainder of iron (Fe) and unavoidable impurities to a temperature within a range of 1000° C. to 1300° C.; hot-rolling the steel slab having been reheated to a finish rolling temperature of 800° C. to 900° C.; cooling a hot-rolled steel plate at a cooling rate of 15° C./s or less after the hot-rolling; and coiling the hot-rolled steel plate under the conditions of Relational Expression 1 to a temperature within a range of 620° C. to 660° C. after the cooling.

4<100((C/12)+(10Ti/48)+(100B/11))+(660−CT)<40 [Relational Expression 1]

Here, C, Ti, and B may be weight contents of respective components, and CT may be a coiling temperature (° C.).

According to another aspect of the present disclosure, a steel pipe for an oil well pipe may include: carbon (C): 0.2 wt % to 0.3 wt %, silicon (Si): 0.10 wt % to 0.50 wt %, manganese (Mn): 1.0 wt % to 2.0 wt %, titanium (Ti): 0.01 wt % to 0.03 wt %, boron (B): 0.001 wt % to 0.005 wt %, calcium (Ca): 0.001 wt % to 0.006 wt %, nitrogen (N): 0.008 wt % or less, aluminum (Al): 0.01 wt % to 0.05 wt %, phosphorous (P): 0.025 wt % or less, sulfur (S): 0.005 wt % or less, with a remainder of iron (Fe) and unavoidable impurities, and may have a yield strength of 379 MPa to 552 MPa and a tensile strength of 517 MPa or more before heat treatment after making a pipe.

According to another aspect of the present disclosure, a method of manufacturing a steel pipe for an oil well pipe may include: reheating a steel slab including carbon (C): 0.2 wt % to 0.3 wt %, silicon (Si): 0.10 wt % to 0.50 wt %, manganese (Mn): 1.0 wt % to 2.0 wt %, titanium (Ti): 0.01 wt % to 0.03 wt %, boron (B): 0.001 wt % to 0.005 wt %, calcium (Ca): 0.001 wt % to 0.006 wt %, nitrogen (N): 0.008 wt % or less, aluminum (Al): 0.01 wt % to 0.05 wt %, phosphorous (P): 0.025 wt % or less, sulfur (S): 0.005 wt % or less, with a remainder of iron (Fe) and unavoidable impurities to a temperature within a range of 1000° C. to 1300° C.; hot-rolling the steel slab having been reheated to a finish rolling temperature of 800° C. to 900° C.; cooling the steel slab at a cooling rate of 15° C./s or less after the hot-rolling; manufacturing a hot rolled steel plate by coiling the hot rolled steel plate under the conditions of Relational Expression 1 to a temperature within a range of 620° C. to 660° C. after the cooling; and making a pipe by electric resistance welding of the hot rolled steel plate having been manufactured.

4<100((C/12)+(10Ti/48)+(100B/11))+(660−CT)<40 [Relational Expression 1]

Here, C, Ti, and B may be weight contents of respective components, and CT may be a coiling temperature (° C.).

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is an image of a microstructure before heat treatment, after pipe-making, according to Inventive Example 1 of an exemplary embodiment;

FIG. 2 is an image of a microstructure after heat treatment, after pipe-making, according to Inventive Example 1 of an exemplary embodiment; and

FIG. 3 is a schematic diagram illustrating quenching and tempering (QT) heat treatment conditions after pipe-making provided in the present invention.

FIG. 4 is an image of a microstructure of Comparative Example 1 of an exemplary embodiment, after pipe-making and heat treatment.

FIG. 5 is an image of a microstructure of Comparative Example 3 of an exemplary embodiment, before heat treatment after pipe-making.

### DETAILED DESCRIPTION

The inventors of the present invention have conducted intensive research into improving the material properties of a material having integrated characteristics of steel grades, suitable for an oil well pipe, demand for which is continuously increasing for use in oil and gas mining pipes. In detail, a hot rolled steel plate for an oil well pipe having strength equivalent to API specification 5CT J55 grade (55 Ksi-grade) steel, before heat treatment, after a welded steel pipe is manufactured, and having strength equivalent to API specification 5CT P110 grade (110 Ksi-grade) steel after heat treating is provided.

Hereinafter, a hot rolled steel plate according to the present invention and a welded steel pipe manufactured using the same are described in detail.

First, the composition of a hot rolled steel plate according to the present invention will be described in detail (hereinafter, wt %). A hot rolled steel plate according to the present invention includes: carbon (C): 0.2% to 0.3%, silicon (Si): 0.10% to 0.50%, manganese (Mn): 1.0% to 2.0%, titanium (Ti): 0.01% to 0.03%, boron (B): 0.001% to 0.005%, calcium (Ca): 0.001% to 0.006%, nitrogen (N): 0.008 wt % or less (excluding 0%), and a remainder of iron (Fe) and unavoidable impurities.

C (Carbon): 0.2% to 0.3%

C is an element affecting strength, toughness, and weld toughness of a weld zone. In addition, C, being an element increasing hardenability of a steel, increases tensile strength as well as yield strength, by increasing a fraction of pearlite by delaying ferrite transformation during cooling after hot finish rolling. However, when the content of C is less than 0.2%, formation of pearlite may be insufficient, so the strength intended in the present invention may not be secured. When the content of C exceeds 0.3%, toughness may be lowered, and weldability may be caused to be lowered during electric resistance welding (ERW). Therefore, the content of C is preferably 0.2% to 0.3%.

Si (Silicon): 0.10% to 0.50%

Si is an element increasing a degree of activity of C in a ferrite phase, promoting stabilization of ferrite, and contributing to securing strength by solid solution strengthening. In addition, a low melting point oxide, such as Mn₂SiO₄, is formed during electric resistance welding, so that the oxide is easily discharged during welding. When a content of Si is less than 0.1%, a cost problem in a steelmaking process may occur. When the content of Si exceeds 0.5%, a formation amount of SiO₂, a high melting point oxide other than Mn₂SiO₄, increases, so toughness of a weld zone may be lowered during electric resistance welding. Therefore, the content of Si is preferably 0.1% to 0.5%.

Mn (Manganese): 1.0% to 2.0%

Mn is an element having a significant effect on an austenite/ferrite transformation initiation temperature, and lowering a transformation initiation temperature, and has an effect on toughness of a pipe base material and a weld zone. As a solid solution strengthening element, Mn also contributes to an increase in strength. When the content of Mn is less than 1.0%, it is difficult to expect the effect described above. When the content of Mn exceeds 2.0%, there is high probability of the occurrence of segregation. Therefore, the content of Mn is preferably 1.0% to 2.0%.

Ti (Titanium): 0.01% to 0.03%

Ti reacts with C and N to form Ti(C,N), and thus suppresses growth of an austenite grains in a welding heat affected zone (HAZ) in addition to when a slab is reheated, thereby serving to increase strength. To this end, Ti should be added in an addition amount exceeding 3.4N, so Ti is preferably added in an amount of 0.01% or more. However, when an amount of Ti is significantly high, toughness may be lowered due to coarsening of TiN or the like. Therefore, an upper limit of Ti is preferably 0.03%.

B (Boron): 0.001% to 0.005%

B is an element improving hardenability of steel by slowing ferrite nucleation in a grain boundary while stabilizing austenite through lowering grain boundary energy by being segregated into an austenite grain. However, when the content of B is less than 0.001%, it is difficult to expect the effect described above. When the content of B exceeds 0.005%, boride is easily formed, so brittleness of steel is rapidly increased. Therefore, the content of B is preferably 0.005% or less.

Ca (Calcium): 0.001% to 0.006%

Ca is an element added to control a form of emulsion. When the content exceeds 0.006%, Ca is excessively added with respect to the content of S in steel, so that a CaS cluster may be generated. On the other hand, when the content is less than 0.001%, MnS is generated, so toughness may be lowered. Therefore, the content of Ca is preferably 0.001% to 0.006%.

Furthermore, in order to prevent the CaS cluster from being generated, it is preferable to control the content of Ca and the content of S simultaneously. That is, it is preferable to control the content of Ca according to the contents of S and O in steel.

N (Nitrogen): 0.008% or Less (0% Excluded)

N is an element which causes aging deterioration in a solid state, and is fixed in steel as a nitride of Ti, Al, or the like. When the content exceeds 0.008%, an addition amount of Ti, Al, or the like is inevitably increased. Therefore, the content of N is preferably limited to 0.008% or less.

P (Phosphorus): 0.025% or Less

P is an element which deteriorates toughness as an impurity. Thus, it is preferable to add a lower content of P. However, considering costs in a steelmaking operation, the content of P is preferably 0.025% or less.

S (Sulfur): 0.005% or Less

S is an element easily forming a coarse inclusion and aggravates toughness and crack propagation, so it is preferable to contain S in as small an amount as possible. However, it is preferable to set an upper limit to 0.005% in consideration of costs in a steelmaking operation.

Al (Aluminum): 0.01% to 0.05%

Al is an element having a deoxidizing action with Si. When Al is added in an amount of less than 0.01%, it is difficult to obtain a deoxidizing effect. When Al is added in an amount greater than 0.05%, an alumina aggregate is increased, so toughness may be lowered. Thus, the content of Al is preferably 0.01% to 0.05%.

In addition to the elements described above, the balance includes Fe and unavoidable impurities. However, the addition of other alloying elements is not excluded, and such an addition may not depart from the technical idea of the present invention.

For example, in addition to the alloy composition described above, niobium (Nb) may be further included. Nb is an element having a significant effect on steel by forming a precipitate. Thus, Nb improves strength of steel, as carbonitrides in steel are precipitated or solid solution in Fe is strengthened. In detail, Nb-based precipitates are solidified when a slab is reheated, and are then finely precipitated during hot rolling. Therefore, strength of steel may be effectively increased. However, when Nb, a relatively expensive element, is added in a large amount, a problem in which manufacturing costs are significantly increased may occur. Thus, the content of Nb is preferably 0.03% or less.

Next, a microstructure of a hot rolled steel plate according to an exemplary embodiment will be described in detail. The microstructure of the hot rolled steel plate according to an exemplary embodiment preferably only includes a composite structure of ferrite and pearlite.

In further detail, in a hot rolled steel plate according to an exemplary embodiment, a microstructure in a portion, at a depth of 1 mm below a surface, preferably only includes ferrite in an area fraction of 60% to 80% of pearlite in an area fraction of 20% to 40%. When the microstructure described above is formed, strength is secured while excellent formability is formed during pipe-making, which is advantageous in terms of yield. In addition, the microstructure is a structure capable of manufacturing a steel pipe for an oil well pipe having target strength of J55-grade strength before heat treatment, after pipe-making, and having target strength of P110-grade strength after heat treatment after pipe-making. In addition, the microstructure is suitable for manufacturing a steel pipe for an oil well pipe intended in the present invention. If a steel pipe for an oil well pipe is manufactured under the conditions according to the related art and includes a low temperature transformed structure such as acicular ferrite, bainite, martensite directly beneath a surface, the object of the present invention may not be achieved.

In the present invention, a portion, at a depth of 1 mm below a surface, refers to an outermost surface portion of a steel plate. When a microstructure of the outermost surface portion is controlled as described previously, it is advantageous to secure excellent workability for pipe-making.

A welded steel pipe is manufactured by pipe-making of the hot rolled steel plate. The welded steel pipe is satisfied with the alloy composition and the composition range described above, and the welded steel pipe before the heat treatment after pipe-making is satisfied with conditions of the microstructure described above.

The welded steel pipe before heat treatment after pipe-making has strength of J55-grade, and in detail, has yield strength of 379 MPa to 552 MPa and tensile strength 517 MPa or more.

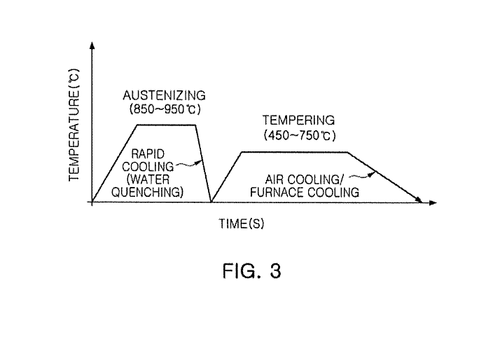

Meanwhile, the welded steel pipe, after a predetermined heat treatment is completed after pipe-making, has P110-grade strength, and in detail, has yield strength of 758 MPa to 965 MPa and tensile strength of 862 MPa or more. An example of the heat treatment after pipe-making may be performed through a quenching and tempering (QT) heat treatment of FIG. 3, which will be described later, and a microstructure after the heat treatment may be changed into tempered martensite.

Hereinafter, a hot rolled steel plate and a method of manufacturing a welded steel pipe manufactured using the same according to the present invention will be described in detail.

A hot rolled steel plate according to the present invention is manufactured in operations of reheating a steel slab satisfied with the composition described above, hot-rolling, cooling, and coiling the same, and each operation will be described in detail below.

Reheating of the steel slab is preferably performed at a temperature within a range of 1000° C. to 1300° C. A reheating operation of a slab is an operation of heating steel so as to smoothly perform a subsequent rolling operation and to obtain sufficient desired material properties in a steel plate. A heating operation should be performed within an appropriate temperature range for the purpose. When a slab is heated, if a heating temperature is less than 1000° C., there may be limitations in uniformly heating the slab. If the heating temperature exceeds 1300° C., an initial grain size may be significantly large, so that it may be difficult to be micronized by reducing a grain size.

During the hot-rolling, finish rolling is preferably performed at 800° C. to 900° C., a non-recrystallization temperature region after rough-rolling. The rough-rolling is preferably performed at 900° C. to 1100° C. When the rough-rolling is terminated at a temperature lower than 900° C., a risk, in which equipment load of a rolling mill occurs, may be increased. Finish rolling, subsequent to the rough-rolling, is preferably performed at 800° C. to 900° C. When a finish rolling temperature is less than 800° C., there is a risk of malfunctions, due to rolling load. When the finish rolling temperature exceeds 900° C., a final structure becomes coarse, so a problem in which target strength is not secured may occur.

Cooling, after the hot-rolling, is preferably performed at a cooling rate of 15° C./s or less. The cooling rate is an important factor for improving toughness and strength of a steel plate, and for serving to determine a microstructure in the present invention. As the cooling rate is higher, a grain of an internal structure of a steel plate is refined, so toughness is improved. Moreover, a hard structure is developed inside the steel plate, so strength may be improved. When the cooling rate exceeds 15° C./s, a low temperature transformed structure is formed, so target strength may be exceeded or impact toughness may be lowered. In the present invention, a low density laminar spray is used to control the cooling rate to be 15° C./s or less, so it is preferable to only include ferrite and pearlite phases, even at a depth of 1 mm below a surface.

In the low density laminar spray, water pressure or a size of a nozzle is smaller, compared to a laminar spray manner used in a cooling operated according to the related art, so a cooling rate may be lowered, partial super cooling may not occur in a width direction and a thickness direction, and uniform cooling may be performed even directly below a surface.

Meanwhile, in order to control an internal structure of a steel plate, cooling is required to be performed to a temperature at which an effect of a cooling rate is able to be sufficiently exhibited. The cooling is preferably performed to a coiling temperature. In the present invention, the coiling temperature is preferably 620° C. to 660° C.

The coiling temperature described above is provided to secure a proper amount of ferrite and pearlite. If the coiling temperature is significantly high, coarse ferrite and pearlite may be generated, and thus, secured strength may be limited. If the coiling temperature exceeds 660° C., due to the formation of coarse grains, a yield ratio may decrease, but problems in which toughness is lowered and strength is less than target strength may occur. If the coiling temperature is lower than 620°, a low temperature, a structure becomes fine, so strength and toughness may be increased, but yield strength after pipe-making using a steel pipe may be significantly increased. Thus, an upper limit of target yield strength is exceeded, so a yield ratio may be increased.

On the other hand, the component of C, Ti, and B and a coiling temperature according to the present invention are preferably satisfied with Relational Expression 1.

4<100((C/12)+(10Ti/48)+(100B/11))+(660−CT)<40 [Relational Expression 1]

Here, C, Ti, and B are weight contents of respective components, and CT is a coiling temperature (° C.).

C, Ti, and B are elements effective for improving strength before and after heat treatment of a steel. If the content thereof is low, strength may be lower than a target strength level, so a coiling temperature should be significantly lowered. If the content thereof is excessive, a coiling temperature should be increased.

In detail, excessive segregation of C and B is suppressed, and strength is secured according to an appropriate amount of Ti while a proper coiling temperature should be secured. Thus, C, Ti, and B are preferably satisfied with a Relational Expression within a proposed range of a coiling temperature.

Meanwhile, the hot rolled steel plate manufactured as described above is used to manufacture a steel pipe. A method of manufacturing the steel pipe is not particularly limited, but pipe-making using electric resistance welding (ERW) is preferable. During electric resistance welding, any welding method may be used, so a welding method is not particularly limited.

When a steel pipe is manufactured, it is preferable to use a hot rolled steel plate of which a thickness is 13 mm or less. In this regard, usually, as a thickness is increased, it is limited to secure high strength and toughness with a component system proposed in the present invention. It is preferable to limit a thickness of a steel plate to 13 mm or less in terms of a manufacturing process and production costs.

After pipe-making using the hot rolled steel plate manufactured as described above, a steel pipe obtained by welding may be quenching and tempering (QT) heat treated. In FIG. 3, the QT heat treatment in a method of manufacturing a steel pipe for an oil well pipe according to an exemplary embodiment of the present invention is illustrated. Referring to FIG. 3, during the QT heat treatment, after austenite is formed by austenizing at 850° C. to 950° C., the austenite is transformed into martensite by quenching. Hereinafter, by tempering at 450° C. to 750° C., toughness is improved. Here, the time of performing the austenizing and tempering is not particularly limited. In consideration of productivity, it is preferable to perform austenizing within 5 minutes and tempering within 3 minutes.

Hereinafter, an exemplary embodiment according to the present invention will be described in detail. The exemplary embodiment is for the purpose of understanding the present invention and is not intended to limit the scope of the present invention.

### Example

After the steel slab having the element composition (wt %, with a remainder of iron (Fe) and unavoidable impurities) of Table 1 was reheated to 1180° C., rough-rolling was performed at 1000° C., and finish rolling was performed at 850° C., so hot-rolling was performed. Thereafter, cooling was performed at a cooling rate of 15° C./s or less, and coiling was performed under the conditions of Table 1, so a hot rolled steel plate was manufactured.

A fraction of a microstructure, at a depth of 1 mm below a surface of the hot rolled steel plate manufactured as described above, yield strength, and tensile strength were measured, and results thereof are illustrated in Table 2. Regarding the yield strength and tensile strength, a test was conducted according to commonly used ASTM A370.

On the other hand, pipe-making was performed in an electric resistance welding (ERW) manner using the hot rolled steel plate having been manufactured, so a steel pipe of which a diameter was 4 inches to 10 inches was manufactured. After pipe-making, a heat treatment was performed. In this case, regarding the heat treatment, after heating was performed to 950° C. and rapid cooling was then performed, tempering was performed at 550° C.

Yield strength and tensile strength before and after the heat treatment were measured, and results thereof are illustrated in Table 2.

TABLE 1

| | Composition (wt %) | | | | | | | | | | | | Temper- | Relational |
|---|---|---|---|---|---|---|---|---|---|---|---|---|---|---|
| No. | C | Si | Mn | Ti | B | Ca | N | P | S | Al | Nb | CT(° C.) | ing(° C.) | Expression 1 |
| Inventive | 0.23 | 0.19 | 1.08 | 0.018 | 0.0016 | 0.0014 | 0.0042 | 0.0098 | 0.0013 | 0.029 | 0.001 | 659 | 560 | 4.7 |
| Example 1 | | | | | | | | | | | | | | |
| Inventive | 0.23 | 0.19 | 1.08 | 0.018 | 0.0016 | 0.0014 | 0.0042 | 0.0098 | 0.0013 | 0.029 | 0.001 | 659 | 575 | 4.7 |
| Example 2 | | | | | | | | | | | | | | |
| Comparative | 0.25 | 0.2 | 1.4 | 0.002 | 0.0001 | 0.0014 | 0.0045 | 0.0051 | 0.001 | 0.031 | 0.009 | 615 | 560 | 47.2 |
| Example 1 | | | | | | | | | | | | | | |
| Comparative | 0.25 | 0.2 | 1.4 | 0.002 | 0.0001 | 0.0014 | 0.0045 | 0.0051 | 0.001 | 0.031 | 0.009 | 615 | 575 | 47.2 |
| Example 2 | | | | | | | | | | | | | | |
| Inventive | 0.24 | 0.19 | 1.28 | 0.010 | 0.0010 | 0.0016 | 0.0048 | 0.011 | 0.0014 | 0.031 | 0.002 | 649 | 560 | 14.1 |
| Example 3 | | | | | | | | | | | | | | |
| Inventive | 0.25 | 0.2 | 1.4 | 0.025 | 0.0019 | 0.002 | 0.0034 | 0.0085 | 0.001 | 0.03 | 0.012 | 628 | 550 | 36.3 |
| Example 4 | | | | | | | | | | | | | | |
| Comparative | 0.24 | 0.2 | 1.1 | 0.02 | 0.002 | 0.002 | 0.0046 | 0.0098 | 0.0013 | 0.029 | — | 620 | 575 | 44.2 |
| Example 3 | | | | | | | | | | | | | | |
| Comparative | 0.24 | 0.2 | 1.1 | 0.02 | 0.002 | 0.002 | 0.0046 | 0.0098 | 0.0013 | 0.029 | — | 610 | 575 | 54.2 |
| Example 4 | | | | | | | | | | | | | | |

In Table 1, CT means a coiling temperature, and Relational Expression 1 means a value of 100((C/12)+(10Ti/48)+(100B/11))+(660−CT).

TABLE 2

| | Microstructure | Hot rolled steel | | Before heat | | After heat | |
|---|---|---|---|---|---|---|---|
| | at depth of | plate (before | | treatment after | | treatment after | |
| | 1 mm below | pipe-making) | | pipe-making | | pipe-making | |
| No. | surface | YS(MPa) | TS(MPa) | YS(MPa) | TS(MPa) | YS(MPa) | TS(MPa) |
| Inventive | 68F + 32P | 340 | 554 | 523 | 573 | 834 | 888 |
| Example 1 | | | | | | | |
| Inventive | 68F + 32P | 340 | 554 | 523 | 573 | 820 | 867 |
| Example 2 | | | | | | | |
| Comparative | 78F + 20P + | 432 | 643 | 454 | 659 | 760 | 812 |
| Example 1 | 2B | | | | | | |
| Comparative | 78F + 20P + | 432 | 643 | 431 | 660 | 724 | 780 |
| Example 2 | 2B | | | | | | |
| Inventive | 70F + 30P | 387 | 563 | 512 | 584 | 831 | 875 |
| Example 3 | | | | | | | |
| Inventive | 79F + 21P | 394 | 625 | 439 | 654 | 912 | 972 |
| Example 4 | | | | | | | |
| Comparative | 65F + 25P + | 430 | 618 | 570 | 642 | 818 | 877 |
| Example 3 | 10B | | | | | | |
| Comparative | 67F + 18P + | 478 | 632 | 640 | 702 | 823 | 882 |
| Example 4 | 15B | | | | | | |

In Table 2, ‘F’ means ferrite, ‘P’ means pearlite, ‘B’ means bainite, YS means yield strength, and TS means tensile strength.

As illustrated in Tables 1 and 2, it is confirmed that, in Inventive Examples 1 through 4 satisfied the conditions proposed in the present invention, yield strength and tensile strength before and after heat treatment, after a welded steel pipe was manufactured, satisfy target values.

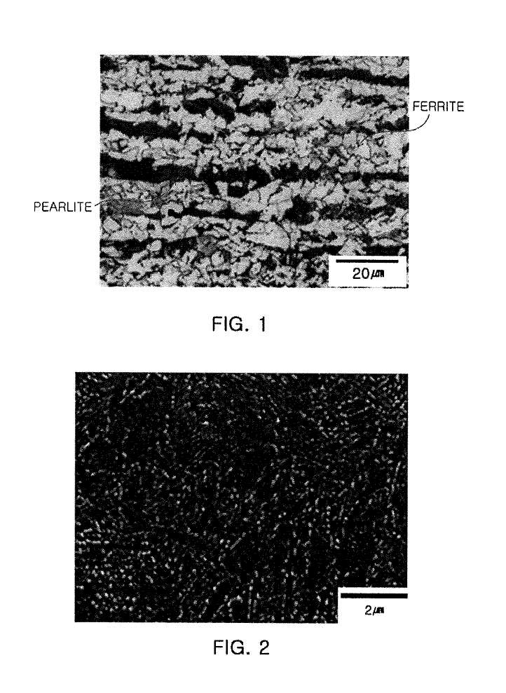

In detail, FIG. 1 is an image of a microstructure of Inventive Example 1, at a depth of 1 mm below a surface, before heat treatment, after pipe-making. It is confirmed that an area fraction of a white ferrite zone is 68% and an area fraction of a black ferrite zone was 32%. FIG. 2 is an image of a microstructure of Inventive Example 1 after heat treatment, after pipe-making, and it is confirmed that a microstructure, after heat treatment, was formed of tempered martensite.

However, in the case of Comparative Examples 1 and 2, outside of the range according to the present invention, after heat treatment, after pipe-making, hardenability was insufficient, so P110-grade strength was not secured. In the case of Comparative Examples 3 and 4, as a bainite structure was formed in a hot rolled steel plate, a welded steel pipe before heat treatment after pipe-making was not satisfied with a target value.

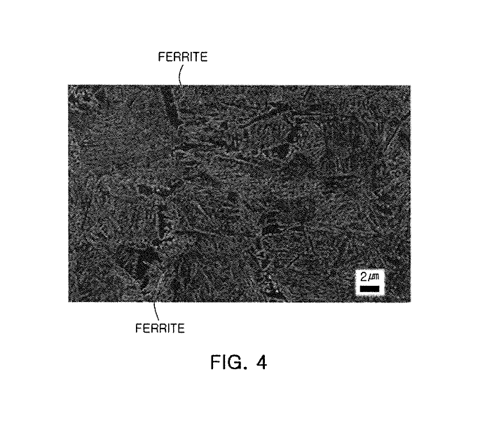

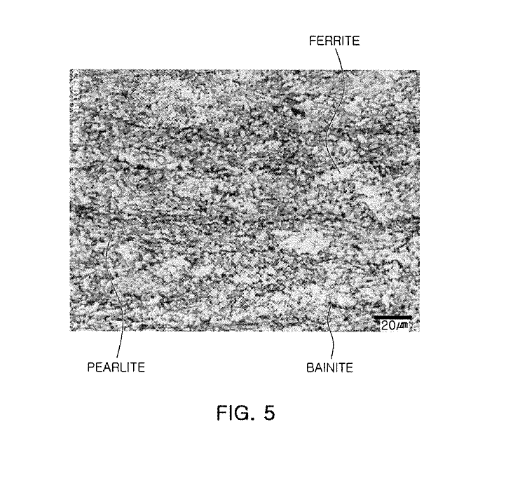

Meanwhile, FIG. 4 is an image of a microstructure of Comparative Example 1 after heat treatment after pipe-making. Here, a ferrite region is present in a portion of a martensite matrix structure, and it is confirmed that strength was not secured after heat treatment. FIG. 5 is an image of a microstructure of Comparative Example 3 before heat treatment after pipe-making, and it is confirmed that bainite was formed in a portion of a ferrite and pearlite matrix.

As set forth above, according to an exemplary embodiment, after forming and welding are performed as a steel pipe, a welded steel pipe having strength of an API specification 5CT J55 (55 Ksi-grade yield strength) before heat treatment, and having strength of an API specification 5CT P110 (110 Ksi-grade yield strength) after heat treatment, may be provided, and the welded steel pipe may be suitably applied as a steel pipe for an oil well.

While exemplary embodiments have been shown and described above, it will be apparent to those skilled in the art that modifications and variations could be made without departing from the scope of the present invention as defined by the appended claims.

What is claimed is:

1. A hot rolled steel plate for an oil well pipe, comprising:
carbon (C): 0.2 wt % to 0.3 wt %, silicon (Si): 0.10 wt % to 0.50 wt %, manganese (Mn): 1.0 wt % to 2.0 wt %, titanium (Ti): 0.01 wt % to 0.03 wt %, boron (B): 0.001 wt % to 0.005 wt %, calcium (Ca): 0.001 wt % to 0.006 wt %, nitrogen (N): 0.008 wt % or less, aluminum (Al): 0.01 wt % to 0.05 wt %, phosphorous (P): 0.025 wt % or less, sulfur (S): 0.005 wt % or less, with a remainder of iron (Fe) and unavoidable impurities,
wherein a microstructure, at a depth of 1 mm below a surface, includes ferrite and pearlite.

2. The hot rolled steel plate of claim 1, wherein the hot rolled steel plate further comprises niobium (Nb): 0.03 wt % or less.

3. The hot rolled steel plate of claim 1, wherein the microstructure includes ferrite in an area fraction of 60% to 80% and pearlite in an area fraction of 20% to 40%.

4. The hot rolled steel plate of claim 1, wherein the hot rolled steel plate has a thickness of 13 mm or less.

5. A method of manufacturing a hot rolled steel plate for an oil well pipe, comprising:
reheating a steel slab including
carbon (C): 0.2 wt % to 0.3 wt %, silicon (Si): 0.10 wt % to 0.50 wt %, manganese (Mn): 1.0 wt % to 2.0 wt %, titanium (Ti): 0.01 wt % to 0.03 wt %, boron (B): 0.001 wt % to 0.005 wt %, calcium (Ca): 0.001 wt % to 0.006 wt %, nitrogen (N): 0.008 wt % or less, aluminum (Al): 0.01 wt % to 0.05 wt %, phosphorous (P): 0.025 wt % or less, sulfur (S): 0.005 wt % or less, with a remainder of iron (Fe) and unavoidable impurities to a temperature within a range of 1000° C. to 1300° C.;
hot-rolling the steel slab having been reheated to a finish rolling temperature of 800° C. to 900° C.;
cooling a hot rolled steel plate at a cooling rate of 15° C./s or less after the hot-rolling; and
coiling the hot rolled steel plate under the conditions of Relational Expression 1 at a temperature within a range of 620° C. to 660° C. after the cooling;
4<100((C/12)+(10Ti/48)+(100B/11))+(660−CT)<40 [Relational Expression 1]
where C, Ti, and B are weight contents of respective components, and CT is a coiling temperature (° C.).

6. The method of claim 5, wherein the steel slab further comprises niobium (Nb): 0.03 wt % or less.

7. The method of claim 5, wherein the cooling is performed in a low density laminar spray process.

8. The method of claim 5, wherein the steel slab having been reheated is rough-rolled at a temperature within a range of 900° C. to 1100° C.

9. A steel pipe for an oil well pipe, comprising:
carbon (C): 0.2 wt % to 0.3 wt %, silicon (Si): 0.10 wt % to 0.50 wt %, manganese (Mn): 1.0 wt % to 2.0 wt %, titanium (Ti): 0.01 wt % to 0.03 wt %, boron (B): 0.001 wt % to 0.005 wt %, calcium (Ca): 0.001 wt % to 0.006 wt %, nitrogen (N): 0.008 wt % or less, aluminum (Al): 0.01 wt % to 0.05 wt %, phosphorous (P): 0.025 wt % or less, sulfur (S): 0.005 wt % or less, with a remainder of iron (Fe) and unavoidable impurities, and
having a yield strength of 379 MPa to 552 MPa and a tensile strength of 517 MPa or more before heat treatment after making a pipe.

10. The steel pipe of claim 9, wherein the steel pipe further comprises niobium (Nb): 0.03 wt % or less.

11. The steel pipe of claim 9, wherein, after the steel pipe is heat treated, the steel pipe has a yield strength of 758 MPa to 965 MPa and a tensile strength of 862 MPa or more.

12. The steel pipe of claim 11, wherein a microstructure of the steel pipe includes tempered martensite.

13. A method of manufacturing a steel pipe for an oil well pipe, comprising:
reheating a steel slab including:
carbon (C): 0.2 wt % to 0.3 wt %, silicon (Si): 0.10 wt % to 0.50 wt %, manganese (Mn): 1.0 wt % to 2.0 wt %, titanium (Ti): 0.01 wt % to 0.03 wt %, boron (B): 0.001 wt % to 0.005 wt %, calcium (Ca): 0.001 wt % to 0.006 wt %, nitrogen (N): 0.008 wt % or less, aluminum (Al): 0.01 wt % to 0.05 wt %, phosphorous (P): 0.025 wt % or less, sulfur (S): 0.005 wt % or less, with a remainder of iron (Fe) and unavoidable impurities to a temperature within a range of 1000° C. to 1300° C.;
hot-rolling the steel slab having been reheated to a finish rolling temperature of 800° C. to 900° C.;
cooling a hot rolled steel plate at a cooling rate of 15° C./s or less after the hot-rolling;
manufacturing the hot rolled steel plate by coiling the steel slab under the conditions of Relational Expression 1 to a temperature within a range of 620° C. to 660° C. after the cooling; and
making a pipe by electric resistance welding the hot rolled steel plate having been manufactured;
4<100((C/12)+(10Ti/48)+(100B/11))+(660−CT)<40 [Relational Expression 1]
where C, Ti, and B are weight contents of respective components, and CT is a coiling temperature (° C.).

14. The method of claim 13, wherein, after the making of a pipe, heat treatment is performed, in which the pipe is heated at a temperature of 850° C. to 950° C. and is then rapid cooled, and is tempered at 450° C. to 750° C.
